(19) United States
(12) Patent Application Publication
(10) Pub. No.: US 2003/0154382 A1
(43) Pub. Date: Aug. 14, 2003

(54) User authentication method and system

(76) Inventor: Dominique Vicard, Bernin (FR)

Correspondence Address: c/o LADAS & PARRY, Suite 2100, 5670 Wilshire Boulevard, Los Angeles, CA, 90036-5679, US

(21) Appl. No.: 10/347,124

(22) Filed: Jan. 17, 2003

(30) Foreign Application Priority Data
Jan. 18, 2002 (EP) 02354009.9

(51) Int. Cl. H04K 1/00

(52) U.S. Cl. 713/186

(57) ABSTRACT

A method of authenticating a user of a security token which has confidential information accessible only in response to a predetermined access code, the method including capturing biometric information of the user, creating a user biometric profile from the captured biometric information, comparing the user biometric profile created from the captured biometric information with a plurality of a biometric profiles contained within a database containing the user biometric profile and other biometric profiles, each biometric profile in the database of biometric profiles having a unique associated code, selecting from the database of biometric profiles the biometric profile corresponding most closely to the user profile created from the captured biometric data, and providing the code associated with the selected biometric profile to the security token.

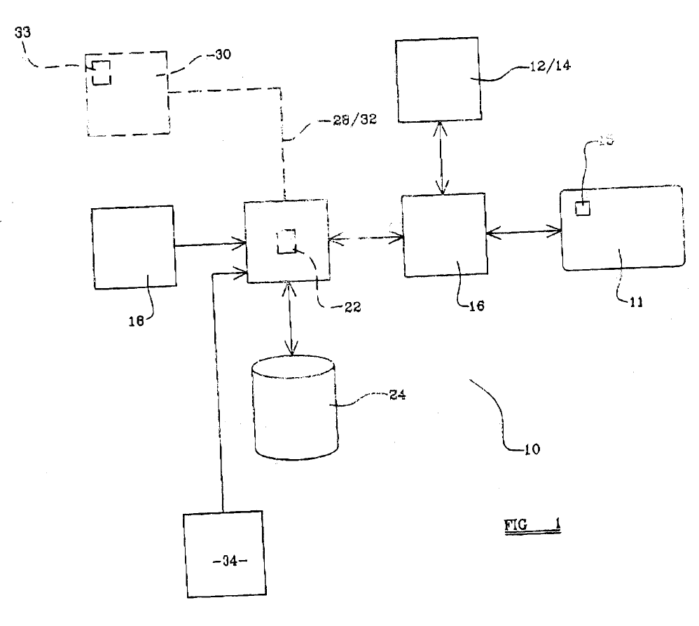

This invention relates to a method of authenticating a user of a security token such as for example only, a smart card.

A smart card or the like system may be used to access a secure device or installation such as a mobile telephone or other personal digital assistant, or a computer platform, for example. A smart card or the like security token requires a predetermined access code, such as a password or PIN number, in order to allow access to confidential information which needs to be retrieved to allow access to the secure device or installation.

It has been proposed to replace security tokens with biometric readers which capture biometric information of a user of a secure device or installation, in order to create biometric data. Such biometric information may be a fingerprint, or a retinal, face or iris scan, or even a voice profile for examples only. The biometric data created from the biometric information is a user profile which may then be compared with one or more user profiles previously created from reference biometric information relating to the or each authorised user of a secure device or installation. If a match for the user profile created from the biometric information captured from the user is found with the user profile or profiles created from the reference biometric information, then the user is allowed access to the secure device or installation.

However such proposals have dangers in that any database of authorised users' user profiles if compromised, cannot again be made secure, as physical characteristics of a user which give rise to specific biometric information of a user, cannot readily be changed. Particularly, if a physical characteristic of an authorised user of the secure device or installation is counterfeited or duplicated by a determined impersonator, no amendment of the database can be made which would both secure the device or installation against an impersonator and permit the authorised user to continue to access the secure device or installation.

Sole reliance on physical characteristics of an authorised user to access a secure device or installation can also present physical danger to the authorised user, as a determined impersonator would need to use force against the authorised user or use a relevant physical part of the authorised user, to enable the biometric information necessary to be capture to access the secure device or installation.

It has also been proposed, for example in our previous patent application WO-A-01/2773 to capture biometric information of the user, to create biometric data which is compared with biometric data stored on a security token. If the biometric data created from the captured biometric information matches the biometric data stored on the security token, then the user is permitted to access the secure device or installation.

However, the amount of biometric data which needs to be stored on the security token for reliable comparison with the biometric data created from the captured biometric information is prohibitive with today's technology, and moreover the system proposed still presents a physical risk to an authorised user.

According to one aspect of the invention we provide a method of authenticating a user of a security token which has confidential information accessible only in response to a predetermined access code, the method including capturing biometric information of the user, creating a user biometric profile from the captured biometric information, comparing the user biometric profile created from the captured biometric information with a plurality of a biometric profiles contained within a database containing the user biometric profile and other biometric profiles, each biometric profile in the database of biometric profiles having a unique associated code, selecting from the database of biometric profiles the biometric profile corresponding most closely to the user profile created from the captured biometric data, and providing the code associated with the selected biometric profile to the security token.

Thus if the code provided to the security token is the predetermined access code, i.e. that required to allow access to the confidential information stored thereon, the confidential information may be sent by or retrieved from the security token to allow access to the secure device or installation.

The present invention provides substantial advantages over known user authentication proposals.

First, if the security of the database of user profiles is compromised, security may be re-established by associating in the database, different unique codes with biometric profiles contained therein, and issuing the authorised user with a replacement security token.

Second, there is no need to store biometric data on the security token, as the security token is only responsive to a predetermined access code to unlock the security token to release its confidential information.

Third, the invention may be used in conjunction with a conventional device or installation which includes a key pad, so that the user may instead of allowing his biometric information to be captured, obtain access to the secure device or installation, by keying in a PIN number and/or password to generate the predetermined access code to the security token. Thus in the event of being threatened by an impersonator, an authorised user may disclose his PIN number and/or password and thus alleviate or reduce the risk of physical injury.

Fourth, even if a potential impersonator obtains both a security token of an authorised user and accesses the information in the database of biometric profiles and associated codes, the potential impersonator would not be able to ascertain which of the biometric profiles has the associated predetermined access code necessary to unlock the security token other than by trial and error, which can readily be guarded against by the providing the security token with a PIN or password locking system which for example locks the security token against all access after a set number of unsuccessful attempts. Thus the security of the biometric profile database need not be as thorough as is required to protect biometric profiles used for the previous methods outlined above.

The database of user biometric profiles and associated codes may be created by capturing reference biometric information from a user to be authorised, storing the user biometric profile in a database, adding to the database a plurality of different biometric profiles, and associating with each of the added biometric profiles in the database, a unique associated code, and associating with the biometric profile of the user, to be authorised, the user's security token access code.

The different biometric profiles which are added to the database may be selected from a larger database of real biometric profiles, or may be selected from a larger database including artificially created biometric profiles or the biometric profiles may be created profiles. In all cases, preferably the different biometric profiles which are added to the database are selected to be significantly different from the user biometric profile, and from others of the added biometric profiles, thus to aid recognition of the authorised user's biometric information when captured subsequently during a user authorisation procedure.

Thus the user biometric profile and the added biometric profiles may be relatively small files of selected biometric data whilst the method may readily identify a biometric profile in the database corresponding to the user biometric profile created from the captured biometric information of the user.

The larger database of biometric profiles from which the biometric profiles to be added to the database are selected, preferably is at a processing station remote from the secure device or installation to which the user requires access using the security token, or where the biometric profiles to be added to the database are created at a processing station, the processing station is preferably located remotely from the secure device or installation, in each case to prevent physical access at the secure device or installation to the processing station where information relating the user biometric profile and an associated access code may be stored.

Wherever the processing station for creating the database of biometric profiles is located the invention enables authorised user authentication without any need to correlate the user's identity with his/her biometric data, and thus the privacy of the user may be preserved.

The secure device or installation may be accessible by a single authorised user, in which case the database of biometric profiles may contain only a single authorised user profile and associated predetermined access code, with there being a single security token. Such a device may be for example a mobile telephone apparatus, or other PDA, with the security token being a subscriber identity module (SIM) or the like in the apparatus.

However the invention may be applied where the secure device or installation has multiple authorised users. Each authorised user may have a security token with a unique predetermined access code, in which case the database of biometric profiles may contain user biometric profiles with associated predetermined access codes for each authorised user. Alternatively, the authorised users may each have security tokens with the same predetermined access code, in which case to prevent an impersonator gaining access to the database of biometric profiles and associated codes and identifying the predetermined access code by seeing the same code associated with several biometric profiles, each biometric profile may include a plurality of associated codes, each of the authorised user biometric profiles including an associated common predetermined access code, but at least some of the other biometric profiles including common associated codes so that the user biometric profiles and the associated predetermined access code cannot readily be identified.

According to a second aspect of the invention we provide a user authentication system including a security token which has confidential information accessible only in response to a predetermined access code provided to the token, a biometric information reader for capturing biometric information of the user, processing means to create a user biometric profile from the captured biometric information, a database for containing the user biometric profile and other biometric profiles, each biometric profile in the database of biometric profiles having a unique associated code, comparator means for comparing the user biometric profile created from the captured biometric information with a plurality of a biometric profiles contained within the database, and for selecting from the database of biometric profiles the biometric profile corresponding most closely to the user profile created from the captured biometric data, and to provide the code associated with the selected biometric profile to the security token.

The biometric reader may for examples be a scanner to scan a fingerprint, iris, retina, or face, or a microphone to record speech or any other reader or combination of readers, to gather the biometric information.

The database of biometric profiles and associated codes may be local to the secure device or installation to be accessed by the user using the security token. However the system may include a remote processing station for creating the database, which remote database may be accessible over a network connection, or in the case of a mobile telephone or other PDA, via a telecommunications link.

The invention will now be described with reference to the accompanying drawing which is a diagrammatic illustration of a user authentication system for use in the invention.

Referring to the drawing there is shown a user authentication system 10 for authenticating that a user of a security token 11 is authorised to access a secure device such as a mobile telephone 12 or other PDA, or a secure installation such as a computer platform 14.

However the system 10 may be used to authenticate the user of a security token 11 in other applications, for example to allow entry access, or to operate a cash dispensing machine.

In this example, the security token 11 is illustrated as a smart card 11, which is of the kind containing confidential information which it is necessary to retrieve from the card 11, to allow the user access to the secure device or installation. Alternatively the security token 11 could be a SIM card for the mobile telephone 12 or other PDA, or any other token which contains confidential information, for example in a microchip 15 or the like on the token 11.

The confidential information is only accessible when a predetermined access code is sent to the card 11 from a smart card interface unit 16 into which the smart card 11 may be introduced. The smart card interface unit 16 may have contacts which make contact with corresponding contacts of the card 11, or a communication path between the card 11 and the interface unit 16 may be achieved by other technologies.

The system 10 further includes a biometric information reader 18. The particular physical characteristic about which the biometric information is read is unimportant to the invention, and the biometric information reader 18 may be of the kind which scans a fingerprint, or retina, face or iris, or may record speech. In each case biometric data is provided to a processor 20 which creates a biometric profile for the user. The processor 20 may if desired, perform some image enhancement to assist in the creation of the user biometric profile.

The biometric profile is compared by a comparator 22, which may be unitary with the processor 20, with a plurality of biometric profiles contained within a local database 24 of biometric profiles and associated codes created as described below. In the event that the comparator 22 finds a match for the biometric profile created from the biometric information read by the reader 18, the processor 20 sends the code associated with the matching biometric profile of the database 24, to the smart card interface unit 16, and hence to the smart card 11. If the code received by the smart card 11 is the predetermined access code, the smart card 11 sends or allows retrieval of the confidential information contained thereby to the interface unit 16, which may then provide the code or at least an access signal to the secure device or installation 12/14 to allow the user access to the device or installation 12/14.

Preferably the database 24 of biometric profiles and associated codes is local to the secure device or installation. The database 24 may typically in a mobile telephone application of the invention, contain in addition to the authorised user's biometric profile and the associated predetermined access code for the security token 11, nine thousand, nine hundred and ninety nine additional biometric profiles and associated codes, none of the codes being operative to unlock the smart card 11 or other security token 11 to allow the confidential information stored thereby to be released to the interface unit 16.

Because the database 24 contains so many biometric profiles and associated codes, even if a potential impersonator of an authorised user was to obtain access to the contents of the database 24, the impersonator would be unable to ascertain which of the codes to use to unlock the smart card 11 or other security token 11. Thus the database 24 need not be subject to substantial security to prevent tampering.

The database 24 may be created with the aid of a remote processing station 30, to which the user authentication system 10 may connect e.g. via a network connection 28, and/or over a telecommunications link 32.

To create the database 24, first, biometric information of an authorised user is read e.g. using the biometric reader 18. Where the biometric information to be used relates to a fingerprint for example, the user may have his/her fingerprint scanned by the device 18. From the biometric information, biometric data may be used by the processor 20 to create a user biometric profile. To minimise the amount of processing power required, preferably the profile is a parametric representation of the fingerprint, perhaps consisting of a map of the fingerprint, logging only key points so that only a relatively small data file for the user's biometric data is required. A parametric representation of a fingerprint may only require thirty to fifty bytes of data storage. Thus the database 24 even when containing ten thousand such biometric profiles (and associated codes) does not require a huge amount of storage space.

Through the network connection 28 and/or communications link 32, the user's biometric profile is sent to the remote processing station 30, which may for example be a remote server. It will be appreciated that there is no correlation between the user's identity and the biometric profile so that the user's privacy is preserved. Such transfer of information may be performed through an Internet anonymiser so that the source of the user biometric profile cannot be traced, for added security, if required.

At the remote processing station 30 there may be a large database 33 of biometric profiles from which a plurality of biometric profiles different to the user's biometric profile are selected. In one embodiment it is envisaged that an additional nine thousand nine hundred and ninety nine biometric profiles may be selected from the large database 33 to add to the user's profile, making ten thousand biometric profiles in total. These ten thousand biometric profiles are then transmitted to the user authenticating system 10, and they are stored in the local database 24.

Whereas the selection of the added biometric profiles from the large database 33 may be random, preferably the added biometric profiles may carefully be selected so as to be significantly different from the user's biometric profile and each other, to aid recognition of the user's fingerprint in subsequent authenticating procedures.

Next, the user may, with the aid of a keypad 34 or other input device, input an access code into the system 10. This access code may be pre-assigned to the user's security token 11, or may be assigned by the user, with there being a later step when the access code is programmed into the smart card 11 or other security token 11. If desired, for the user to assign an access code, authentication of the user, by the user again having his/her fingerprint scanned by the reader 18 may be required.

The access code is then associated with the user's biometric profile in the database 24 and each of the added biometric profiles is randomly assigned an associated code i.e. one of the other nine thousand nine hundred and ninety nine numbers.

With the system 10 thus initiated, an authorised user may access the secure device or installation either by being authenticated in the manner described above, i.e. by having his/her fingerprint scanned by the reader 18, or by keying in the access code via the input device 34.

Various modifications may be made without departing from the scope of the invention.

In the system described the local database 24 of biometric profiles contains only one authorised user biometric profile and associated access code. In another application, the database 24 may contain a plurality of different authorised user biometric profiles. Each authorised user biometric profile may have a unique associated access code, such as a PIN number and/or password, and an authorised user may only access the secure device or installation when having his/her own smart card 11 or other security token 11, as only the user's smart card 11 or other security token 11 can be unlocked with the user's biometric information and associated predetermined access code. With such an arrangement, the level of security decreases with the number of authorised users.

In another arrangement, a plurality of authorised users may each have smart cards 11 or other security tokens to obtain access to the secure device or installation 12/14, but each biometric profile in the database 24 has a plurality of associated codes. Each of the biometric profiles of the authorised users would include the same predetermined access code, but to hide the access code at least some of the codes associated with “dummy” biometric profiles may be duplicated for a plurality of the biometric profiles.

Although a local database of ten thousand biometric profiles and associated codes has been described, it will be appreciated that the local database 24 may contain more or less than this number of records, depending on the degree of security protection required.

To prevent an impersonator gaining access to the database 24 and trying all of the codes until the impersonator happens upon a correct predetermined access code for the smart card 11 or other security token, preferably the smart card 11 or other security token is adapted to lockout after a predetermined number of failed attempts to unlock it. For example, the smart card 11 or other security token may prevent any access at all to the confidential information stored thereby after three unsuccessful attempts at inputting an incorrect access code either via the input device 34, or using the biometric reader 18.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of authenticating a user of a security token (11) which has confidential information accessible only in response to a predetermined access code, the method including capturing biometric information of the user, creating a user biometric profile from the captured biometric information, comparing the user biometric profile created from the captured biometric information with a plurality of a biometric profiles contained within a database (24) containing the user biometric profile and other biometric profiles, each biometric profile in the database (24) of biometric profiles having a unique associated code, selecting from the database (24) of biometric profiles the biometric profile corresponding most closely to the user profile created from the captured biometric data, and providing the code associated with the selected biometric profile to the security token (11).

2. A method according to claim 1 characterised in that the database (24) of user biometric profiles and associated codes is created by capturing reference biometric information from a user to be authorised, storing the user biometric profile in a database (24), adding to the database (24) a plurality of different biometric profiles, and associating with each of the added biometric profiles in the database (24), a unique associated code, and associating with the biometric profile of the user to be authorised, the user's security token (11) access code.

3. A method according to claim 2 characterised in that the different biometric profiles which are added to the database (24) are selected from a larger database (33) of biometric profiles.

4. A method according to claim 2 characterised in that the different biometric profiles which are added to the database (24) are selected from a larger database (33) including artificially created biometric profiles.

5. A method according to any one of claims 2 to 6 characterised in that the different biometric profiles which are added to the database (24) are artificially created profiles.

6. A method according to any one of claims 2 to 5 characterised in that the different biometric profiles which are added to the database (24) are selected to be significantly different from the authorised user's biometric profile, and from others of the added biometric profiles, thus to aid recognition of the authorised user's biometric information when captured subsequently during a user authorisation procedure.

7. A method according to claim 3 or claim 4 characterised in that the larger database (33) of biometric profiles from which the biometric profiles to be added to the database (24) are selected, is at a processing station (30) remote from a secure device or installation (12/14) to which the user requires access using the security token.

8. A method according to claim 5 characterised in that the biometric profiles to be added to the database (24) are created at a processing station (30) located remotely from a secure device or installation (12/14) to which the user requires access using the security token.

9. A method according to claim 8 characterised in that a secure device or installation (12/14) to which the user requires access using the security token is accessible by a single authorised user, the database (24) of biometric profiles containing only a single authorised user profile and associated access code.

10. A method according to any one of claims 1 to 9 characterised in that the system (10) includes a single security token (11).

11. A method according to claim 9 or claim 10 characterised in that the secure device (12) is a mobile telephone apparatus, or other PDA, with the security token (11) being a subscriber identity module (SIM) in the apparatus (12).

12. A method according to any one of claims 1 to 9 characterised in that the secure device or installation (12/14) to which the user requires access using the security token has multiple authorised users, each authorised user having a security token (11) with a unique predetermined access code, the database (24) of biometric profiles containing user biometric profiles with associated predetermined access codes for each authorised user.

13. A method according to any one of claims 1 to 9 characterised in that the secure device or installation (12/14) has multiple authorised users and the authorised users each have security tokens (11) with the same access code, each biometric profile in the local database (24) including a plurality of associated codes, each of the authorised user biometric profiles including an associated common predetermined access code, but at least some of the other biometric profiles including common associated codes so that the user biometric profiles and the associated access code cannot readily be identified.

14. A user authentication system (10) including a security token (11) which has confidential information accessible only in response to a predetermined access code provided to the token (11), a biometric information reader (18) for capturing biometric information of the user, processing means (20) to create a user biometric profile from the captured biometric information, a database (24) for containing the user biometric profile and other biometric profiles, each biometric profile in the database (24) of biometric profiles having a unique associated code, comparator means (22) for comparing the user biometric profile created from the captured biometric information with a plurality of a biometric profiles contained within the database (24), and for selecting from the database (24) of biometric profiles the biometric profile corresponding most closely to the user profile created from the captured biometric data, and to provide the code associated with the selected biometric profile to the security token (11).

15. A system according to claim 14 characterised in that the biometric reader (18) is one of a scanner to scan a fingerprint, iris, retina, or face, or a microphone to record speech or any other reader to gather biometric information.

16. A system according to claim 14 or claim 15 characterised in that the database (24) of biometric profiles and associated codes is local to a secure device or installation (12/14) to be accessed by the user using the security token.

17. A system according to any one of claims 16 to 18 characterised in that the system (10) includes a remote processing station (30) for creating the database (24) which remote database (30) is accessible over a network connection (28) or via a telecommunications link (32).
